(19) United States
(12) Patent Application Publication
(10) Pub. No.: US 2011/0258997 A1
(43) Pub. Date: Oct. 27, 2011

(54) LOW COST LINEAR GENERATOR WAVE ENERGY CONVERTERS

(75) Inventor: Hugh-Peter Granville Kelly, Essex (GB)

(73) Assignee: TRIDENT ENERGY LIMITED, London (GB)

(21) Appl. No.: 13/130,717

(22) PCT Filed: Nov. 27, 2009
(86) PCT No.: PCT/GB2009/002776

§ 371 Date: Jul. 13, 2011

(30) Foreign Application Priority Data
Nov. 28, 2008 (GB) 0821835.6

(51) Int. Cl. F03B 13/18

(52) U.S. Cl. 60/497

(57) ABSTRACT

A wave energy converter comprising: a linear generator comprising an armature and a stator; a float connected by a linkage to the armature; wherein the weight of the armature and the linkage bear downwards upon the float and one of the armature and stator comprises electrical coils and the other of the armature and stator comprises a stack of permanent magnets, the arrangement being such that during the ascending portion of a passing wave, the buoyancy of the float causes the armature to rise, and as the wave falls away, the combined weight of the float, linkage and armature causes the armature to fall, electricity thereby being generated upon the upstroke and the downstroke, the stack of permanent magnets or electrical coils of the armature being sufficiently sized in terms of deadweight to procure that the combined weight of the armature, linkage and float and any other travelling components act sufficiently against the electromotive force being generated by the linear generator upon the downward stroke to ensure that the float descends to the trough of the passing wave.

The following invention relates to wave energy converters using linear generators. In my granted patent no. EP 1 196 690 and foreign equivalents, means are described for the conversion of sea wave energy to electricity. One or more floats, immersed in the sea and undulating with the sea waves, are used to cause relative motion between the armature and stator of one or more linear generators. (Such a linear generator may comprise the motor disclosed in EPO 040 509 and foreign equivalents, but used as a linear generator.) It is one object of the invention disclosed in patent no. EP 1 196 690 for the weight of the linkage means and floats to be arranged to be as little as possible in order to ensure mechanical energy is not lost in overcoming inertial forces.

In a preferred form of this arrangement, the linear generator is mounted in a tower above or below the float and the travelling armature of the generator is connected by a rigid linking means—such as a stiff pole—to the float below or above it. It will be appreciated that any motion of the float thus causes an exact corresponding motion of the armature and that the weight of the armature and any linkage means connecting it to the float, bears in a downwards direction directly upon the float.

The invention the subject of this application is concerned with optimising the power generated by this arrangement, while minimising the capital cost of the principal components comprising the linear generator, and other associated components.

In an aspect of the invention there is provided a wave energy converter comprising:
a linear generator comprising an armature and a stator;
a float connected by a linkage to the armature;
wherein the weight of the armature and the linkage bear downwards upon the float and one of the armature and stator comprises electrical coils and the other of the armature and stator comprises a stack of permanent magnets, the arrangement being such that during the ascending portion of a passing wave, the buoyancy of the float causes the armature to rise, and as the wave falls away, the combined weight of the float, linkage and armature causes the armature to fall, electricity thereby being generated upon the upstroke and the downstroke, the stack of permanent magnets or electrical coils of the armature being sufficiently sized in terms of deadweight to procure that the combined weight of the armature, linkage and float and any other travelling components act sufficiently against the electromotive force being generated by the linear generator upon the downward stroke to ensure that the float descends to the trough of the passing wave.

In this way the stroke available for movement of the armature is optimised thereby ensuring that as much energy as possible can be extracted from any passing wave. For example the deadweight may be enough for the optimal generation of electricity on the upstroke.

In an aspect the electrical coils or stack of permanent magnets of the armature are sufficiently sized in terms of the deadweight to procure that there are sufficient numbers of turns of coils available to be cut by the magnetic fields emanating from the stack of permanent magnets to enable the use of low grade magnetic materials in the stack of permanent magnets while still converting substantially all of the mechanical energy available upon the downstroke or upstroke to electricity.

In this way the required weight of the armature can be achieved through the nature of the material in the stator (i.e. the electrical coils or the stack of permanent magnets). Therefore extra ballast weight may not be necessary and the capital cost of the wave energy converter can be kept relatively low compared to the case where high grade magnetic materials are used which would require less magnetic material and fewer coils. If high grade magnetic materials are used with a commensurately smaller number of turns and with a small amount of magnetic material (comparable to the amount of coils and magnetic material used when low grade magnetic materials are used) extra ballast weight will need to be used in order to ensure a full downstroke and there is a chance that the temperature of the magnetic materials could rise above their Curie point due to the heat generated in the electrical coils as they traverse the magnet stack. The former is disadvantageous because extra energy is required in the upstroke to accelerate and move the ballast weight up which energy is not converted into electricity. The latter is disadvantageous because above the Curie point the magnetic materials no longer produce magnetic fields so that no electricity would be generated, and may be permanently demagnetised.

In an aspect the electrical coils or stack of permanent magnets of the armature are sufficiently sized in terms of the deadweight to procure that, consequent upon the deadweight of the armature, a reduction is effected in the weight of one or more of the other travelling components needed to cause the required downwards movement.

This means that the parasitic weight of the floats and linkage can be minimised and only need to be sized to fulfil their strict function in terms of providing buoyancy and transmission of force and being strong enough to resist deformation during use.

In an aspect the stack of permanent magnets is comprised of magnets of a low grade, for example those known as ferrites and having typically a residual magnetic induction Br ranging between 2000 and 5000 Oersteds. This has considerable cost benefits compared to using high grade magnetic materials.

In an aspect the permanent magnets of the stack have a Curie point of over 200° C. This is advantageous because during use the magnetic materials may easily reach a temperature of over 100° C. If the peak temperature achieved could rise above the Curie point either cooling measures would need to take place resulting in increased complexity and capital cost or else the magnets will lose their magnetic strength and electricity will no longer be generated.

In an aspect of the present invention the weight of the float, linkage and armature is sufficient such that the need for extra ballast weights connected to the float is avoided.

Thus the present invention eliminates the need for and cost of parasitic ballast weight which reduces the overall efficiency of the wave energy converter even if it ensures that the float falls to the trough of the wave.

In an aspect as provided the energies generated during an upstroke and a downstroke are within 20% of each other, preferably substantially equal. This is advantageous because under this condition the wave energy converter converts as much mechanical energy as possible from the wave to electricity during any given wave period.

In an aspect the size of the float and weight of any moving components including the float, linkage and armature are such that the down thrust due to the weight of the moving components equals substantially the up thrust available as the ascending wave acts upon the buoyancy of the float.

This is one way of ensuring that the amount of energy which is generated on the upstroke is substantially equal to the amount of energy generated on the downstroke.

In an aspect the ratio of the length of the stroke of the armature to the diameter of the stack of permanent magnets lies in the range 10:1 to 12:1. This particular range of ratios is advantageous in that if the ratio falls within the given range the capital cost of the wave energy converter is reduced compared to a wave energy converter with a different ratio.

In an aspect of the invention, there is provided a wave energy converter comprising: a linear generator comprising an armature and a stator; a float connected by a linkage to the armature; wherein the weight of the armature and the linkage bear downwards upon the float and one of the armature and stator comprises electrical coils and the other of the armature and stator comprises a stack of permanent magnets, the arrangement being such that during the ascending portion of a passing wave, the buoyancy of the float causes the armature to rise and as the wave falls away, the combined weight of the float, linkage and armature causes the armature to fall, electricity thereby being generated upon the upstroke and the downstroke. This aspect may be combined with any of the features described elsewhere in the application in particular any of features a), b) and/or c) of the next aspect. The wave energy converter of this aspect may be designed for optimal performance for a particular region. For example, the wave energy converter may be designed for optimal performance in the Atlantic or the North Sea. The permanent magnets of the stack of permanent magnets may be comprised of magnets of a low grade, for example those known as ferrites and typically having a residual magnetic induction Br ranging between 2000 and 5000 Oersteds.

In an aspect of the invention, a wave energy converter comprises one or more floats connected by rigid linkage means to the armature(s) of one or more linear generators whereby, in use, the weight of the armature and linkage means bears downwards upon the float(s), the armature(s) of the linear generator housing electrical coils and the stator(s) thereof comprising elongate stacks of alternating permanent magnets and pole pieces, the arrangement being such that during the ascending portion of a passing wave, the buoyancy of the float causes the armature(s) to rise, and as the wave falls away, the combined weight of the float, linkage means and armature(s) causes the armature(s) to fall, electricity thereby being generated both upon the upstroke and the downstroke , the armature being sufficiently sized in terms of the number of coils therein and therefore its dead weight, to procure that

a) the combined weight of the armature and the other travelling components acts sufficiently against the electromotive force being generated upon the downwards stroke to ensure the float descends substantially to its lowest ideal point for the generation of electricity upon the upstroke, b) there are sufficient numbers of turns within the armature available to be cut by the magnetic fields emanating from the stator to enable the use of low grade magnetic materials therein while still converting substantially all of the mechanical energy available upon the upstroke or downstroke to electricity and c) consequent upon the said dead weight of the armature, a reduction is effected in the weight(s) of one or more of the other travelling components needed to cause the required said downwards movement.

In an alternative arrangement, the armature may comprise the elongate stack of permanent magnets, and the stator, the electrical coils. In this case, the float causes the longitudinal stack of magnets to rise and fall, while the coils remain stationery.

In a preferred embodiment of the invention, the ratio of the number of coils and their diameter used in the armature, and therefore their cost, relative to the volume and therefore the cost of the permanent magnets used in the stator, is so selected such as to minimise their overall combined cost while still satisfying the need for adequate armature weight to ensure the said descent of the float upon the downstroke.

According to an aspect of the aforesaid preferred embodiment, the said ratio may be further advantageously modified to take into account the commensurate cost of other components forming part of the wave energy converter and influenced by the length of the stator. Examples would be the height of the cage housing the linear generators, and the length of the linkage means coupling the armatures to the float.

According to a further aspect of the invention, the low grade magnets may be of the type known as ferrite.

Use of low grade magnets in the stator has one but in fact, only apparent, disadvantage, being that a large number of turns is needed to generate sufficient electromotive force to absorb the mechanical energy available. This gives rise to a relatively expensive armature. However, in comparison to the use of a stator formed, for example, from rare earth magnets, the extra cost of the armature windings is dwarfed by the savings in terms of the cost of the magnetic materials. Low grade ferrite magnets, for example, are currently one thirtieth of the cost of rare earth magnets, such as those known as neodymium boron iron.

In addition, were again rare earth magnets to be used, the length of winding required would be reduced to about one third of that needed in the case of low grade magnets, owing to the fact that the field strength of rare earth magnets is approximately triple that of low grade magnets. This has two disadvantages. First, resistive heat losses in the coils are more concentrated, so limiting performance, and second, the weight of the coils would therefore be commensurately reduced. However, it will be appreciated from the statement of invention that the armature coils, as well as serving the purpose of converting the mechanical energy available to electrical power, also act as part of the overall weight required to ensure the float descends correctly during the downstroke. Thus additional weights would need to be added to ensure the armature, linkage means/float combination falls sufficiently fast upon the downstroke both to convert the mechanical energy available to electricity, and to reach the lowest desirable point ready for ascending with the next wave.

Thus the use of low grade magnets, albeit with the corresponding larger number of armature coils, saves also upon the need and therefore cost of the said additional weights which would otherwise be needed.

In accordance with the invention, an economic generation of electricity is thereby procured in terms of the overall capital cost of the armature and stator components forming the linear generator, as well as other components comprising the body of the energy converter.

By way of ensuring a fuller understanding of the invention, a further explanation follows:

In a wave energy converter as described herein, it is clearly desirable to extract as much electrical energy as possible from the motion of a float. Clearly this is realised when power is generated upon both the upstroke and the downstroke during a float movement cycle. Judicious choice is made of the displacement and therefore buoyancy of the float to ensure sufficient hydrostatic and hydrodynamic force is available from the sea wave acting upon the float during the upstroke to overcome several factors. These are principally a) the combined weight of the float itself, the linkage means and the weight of the armature(s) driven thereby, b) the force needed to overcome the contra-electromotive force experienced as electricity generated, and c) the inertial force necessary to accelerate the respective masses. On the downstroke however, it is principally the weight of the travelling components which is responsible for ensuring the armature(s) falls fast enough both to generate electrical power and to ensure the float is at its lowest ideal point for generating power as the next wave advances.

In the event that the permanent magnets selected for the stator of the linear generator were to be of the type known as rare earth (such as Neodymium Boron Iron), it will be appreciated, given Lenz's law, the length of windings required would be approximately one third of those required were a typical low grade magnet (such as those known as ferrite) to be used, this being approximately the ratio of their respective magnetic field strengths. In this case, there is little weight of copper to contribute towards the gravitational downwards force necessary to ensure correct operation. Some sort of parasitic ballast weight would be necessary.

In the case of the arrangement the subject of this invention, the use of weaker low grade magnets certainly necessitates the use of more windings, but their weight is put to good effect in ensuring the necessary downwards force is obtained, this reducing/eliminating the need for other ballast weights. However, the combined cost of the ferrite magnets and the augmented windings remains far less than were rare earth magnets to be used with a lesser number of windings. A further advantage arises inasmuch that ferrite magnets are corrosion resistant, the raw material is available in abundance and in positive contrast to rare earth magnets, they have a far higher Curie point.

It will be appreciated that the advantages of this invention are applicable both to the case where the armature contains the coils and is the travelling component, or the case where the coils remain stationery and the magnets form the moving component. In this latter case, the effective weight is increased inasmuch that more magnets are required—within a linearly extending stack—to provide adequate flux to be cut by the corresponding larger number of coils.

The invention will now be described with reference to the accompanying drawings in which:

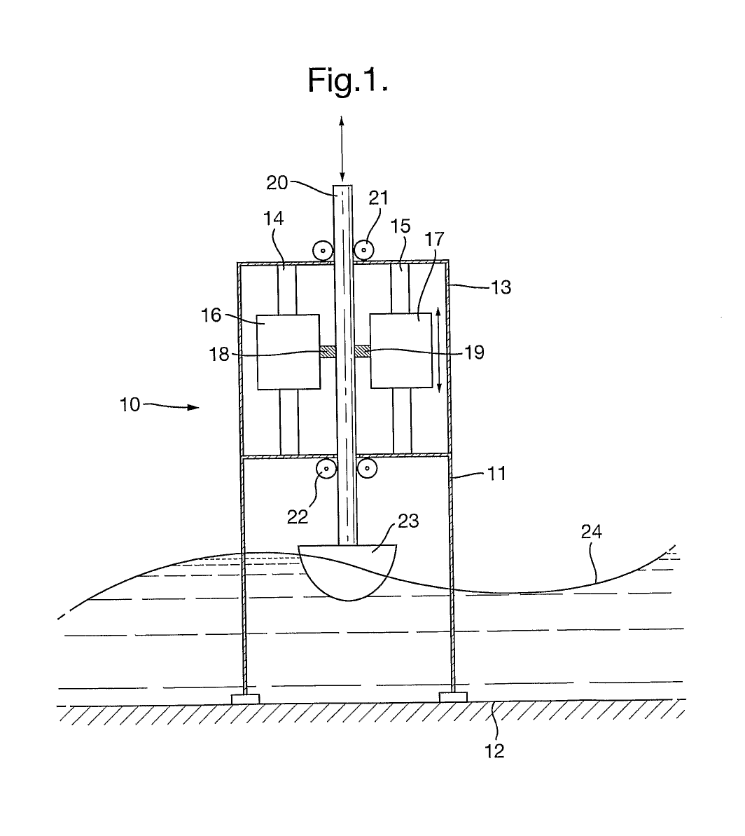

FIG. 1 shows a wave energy converter using a linear generator;

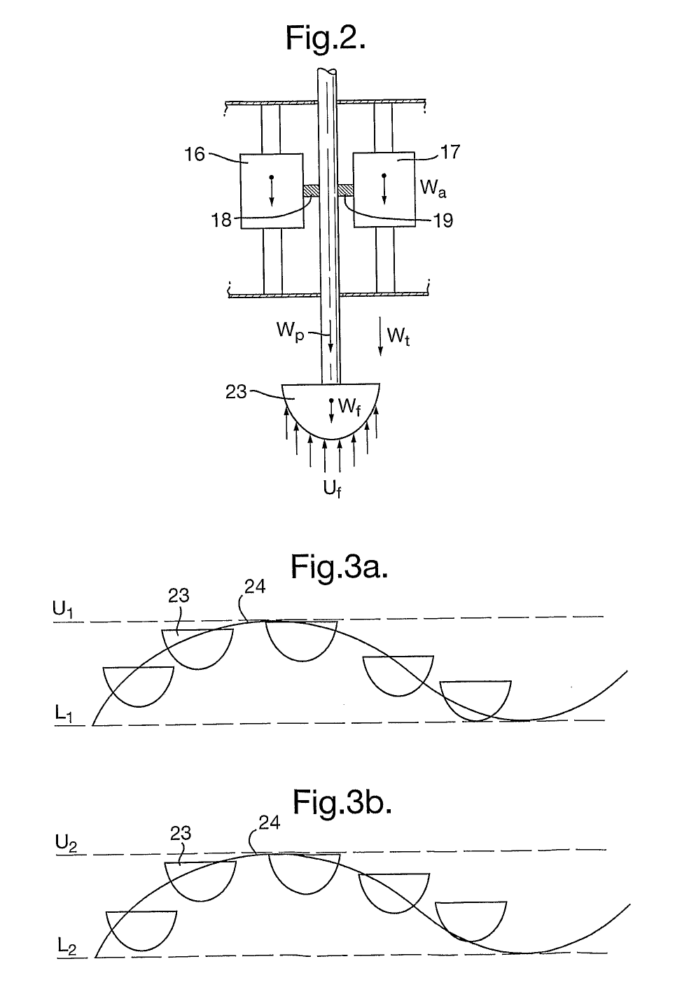

FIG. 2 indicates the forces acting upon the component parts of the converter of FIG. 1;

FIGS. 3a and 3b show two examples of float motion;

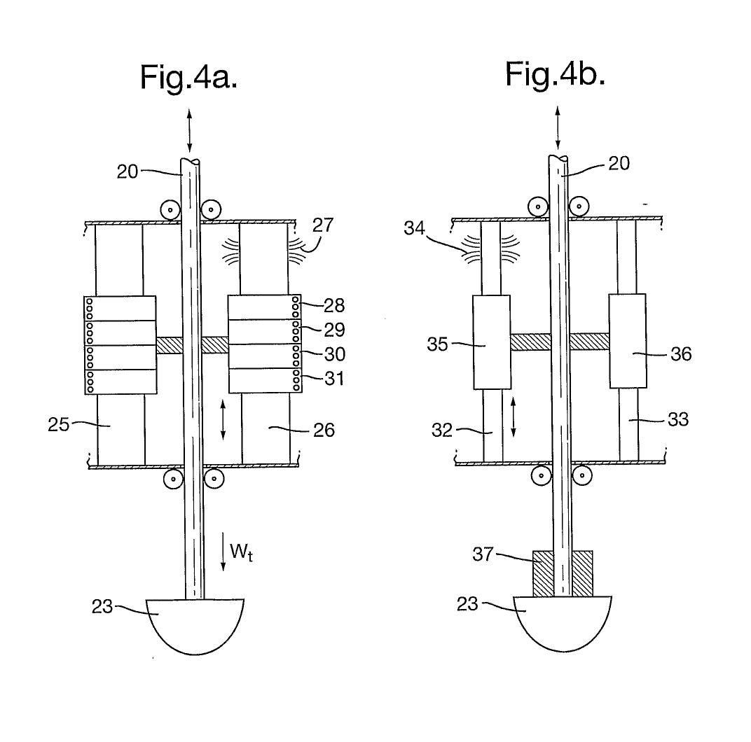

FIGS. 4a and 4b show two possible forms of converter, that of 4a using low grade magnets, and 4b, high grade magnets;

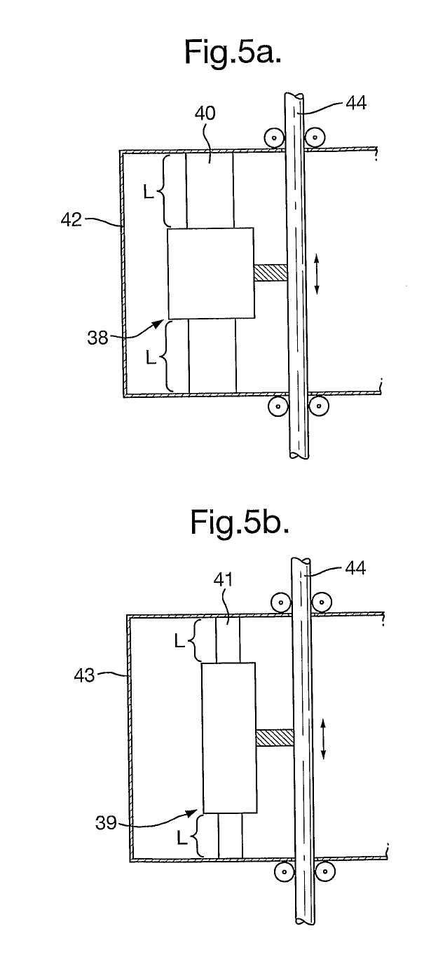

FIGS. 5a and 5b show two possible sizes of linear generators to illustrate their respective costs, as well as that of their surrounding cages; and

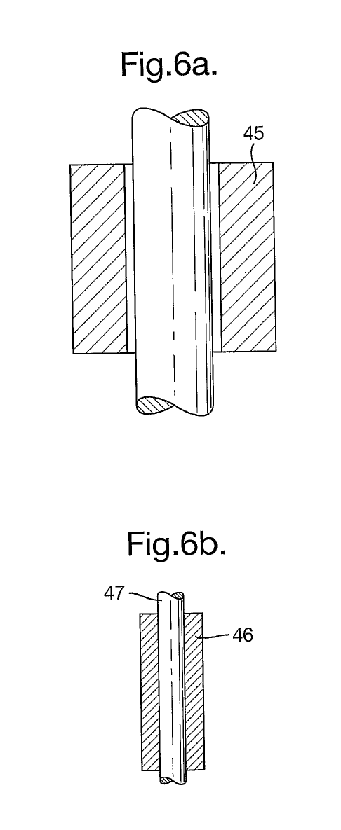

FIGS. 6a and 6b show the comparative influence of heat upon low grade stators, and those using high grade magnets.

Referring to FIG. 1, a wave energy converter is shown generally at 10, and operates as follows. A tower 11, resting on the sea bed 12, supports an upper cage 13. The cage houses stators 14 and 15 of two linear generators. The armatures of the linear generators, 16 and 17, which travel coaxially along the stators, are attached by connecting blocks 18 and 19 to a travelling and rigid central thrust pole 20. The pole passes through sets of guidance rollers 21 and 22 mounted at the top and bottom of the cage 13, and extends down to a float 23. Sea waves, 24, acting upon the float, cause the float to rise, thereby causing, by means of the thrust pole 20, relative motion between the armature and stator of each linear generator. As the wave falls away, the gravitational weight of the moving assembly, components 23,20, 19, 18, 17 and 16, causes downwards movement. Electricity is thereby generated both upon the upstroke and the downstroke.

In an alternative arrangement, not shown, the cage may be submerged, in which case the float is above the cage and is situated at the upper end of the thrust pole, but in all other respects the operation remains the same.

The various forces experienced by the components of the wave energy converter are now shown with reference to FIG. 2.

The aforesaid upthrust acting on the float 23 as the wave (not shown) ascends is shown at Uf. The total gravitational downthrust is shown at Wt, and comprises the weights Wf (the weight of the float 23), Wp (the weight of the thrust pole 20 and the connecting blocks 18 and 19 together hereinafter referred to as the linkage means) and Wa, the weight of the two armatures.

It will be appreciated it is advantageous to convert as much mechanical energy as possible to electricity during any wave period. Generally such extraction is maximised when the said energy is generated near equally upon both the upstroke and the downstroke, rather than biasing energy conversion specifically towards the upstroke or downstroke. If the energies generated on the up stroke and down stroke are within 20% of one another, this is sufficient in some circumstances.

In the case of the arrangement shown, this is clearly achieved when—as the wave falls away—the downthrust Wt on the downstroke (resulting from the weight of the falling components) equals substantially the upthrust Uf as the ascending wave acts upon the buoyancy of the float. Were this not to be the case, motion of the float would be compromised, as shown in FIG. 3b. In the case of FIG. 3a, the float is shown travelling with the waves, ie rising and falling nicely between upper and lower limits U1 and L1. In the case of FIG. 3b however, because there is inadequate weight to overcome the contraelectromotive force on the downstroke, the float fails to fall sufficiently before the next wave arrives, as shown by the upper and lower limits U2 and L2.

Therefore it is desirable that the stack of permanent magnets or electrical coils of the armature are sufficiently sized in terms of deadweight to procure that the combined weight of the armature, linkage and float and any other travelling components acts sufficiently against the electromotive force being generated by the linear generator upon the downstroke to ensure that the float descends to the trough of the passing wave. Put another way, the float descends enough so that it is sufficiently immersed as a trough of the wave passes by it for the optimal generation of electricity upon the downstroke and/or upstroke. In one embodiment the float is sufficiently immersed at the trough such that its buoyancy at least equals the weight of the armature, linkage and float and any other travelling components.

By way of example, for waves having a peak to peak amplitude of 4 meters and a wave period of 5 seconds, a downwards acceleration of at least 2.6 m/s/s would be required to ensure that the float follows the wave. The characteristics of the waves may vary throughout the world. It may be beneficial to provide the wave energy converter such that is customised for the climate where it is located. For example, waves in the Atlantic may have a small or large amplitude but typically have a wave period of a few tens of seconds. For such waves the downwards acceleration required to ensure that the float follows the wave is less. However, for a wave energy converter in the North Sea, waves having a peak to peak amplitude of 4 meters and a wave period of 5 seconds are more common so that a downwards acceleration of at least 2 m/s/s is desired.

The foregoing is germane to an appreciation of the invention as it illustrates the importance of the contribution of each of the individual weights of the travelling components in ensuring the maximum generation of electricity but at the lowest capital cost.

Referring now to FIGS. 4a and 4b, two forms of the wave energy converter are shown, and each to the same reference scale. In the case of both FIGS. 4a and 4b, the float 23 and the linkage means 20, 18 and 19 are physically the same in terms of size and weight.

In the specific case of FIG. 4a, the linear generators, which are of tubular coaxial construction, are shown symbolically using low grade permanent magnets, inasmuch that the stators, 25 and 26, are, according to the reference scale, of a relatively substantial diameter. The magnetic field emanating therefrom is shown symbolically at 27. (Note, for any such design of tubular generator, for a given speed of translation, the electromotive force generated in the armature—the emf—is proportional to the length of the conductors forming the armature and the intensity of the prevailing magnetic field through which they pass.)

Their large diameter is required, given their relatively low magnetic field, in order that—in combination with the number of coils 28-31 comprising each of the armatures—there is sufficient conductor length overall to convert to electricity (in accordance with Lenz's law) substantially all of the mechanical energy available upon the upstroke and downstroke. The weight Wt necessary for optimal downwards travel, as already elucidated, is clearly amply provided by the relatively massive armatures, as well as the linkage means. Indeed, the very size of the armatures means the weight of the linkage means may be kept to the minimum necessary commensurate with adequate mechanical strength to fulfil their purpose. In addition, it may be sufficient to avoid altogether the need for extra ballast weights.

In FIG. 4b however, an alternative arrangement is shown in which the low grade magnet stators of FIG. 4a are now replaced by high grade magnet stators 32 and 33 (using for example, rare earth magnets). Owing to the far greater field intensity emanating therefrom, as shown symbolically at 34, the diameter of the stators is substantially reduced and the armatures 35 and 36 are, correspondingly reduced in diameter also. (The reason again being, as mentioned above, that the emf generated is proportional to the field strength, and because the field strength of rare earth magnets is approximately three times that of low grade magnets, the conductor length is similarly reduced to one third in order to generate the same emf). Consideration of the size of the armatures shows their weight to be reduced in proportion. However, and importantly, because of this reduction in weight, there is now inadequate gravitational weight to provide the desired downwards force, which thus results in unsatisfactory motion of the float, as shown in FIG. 3b. An additional weight 37 must be then added, shown here in FIG. 4b as a collar around the base of the thrust pole.

Concerning the relative costs of the materials used in the two arrangements, the cost of the low grade material magnets used in the stators 25 and 26 of FIG. 4a, is currently approximately one thirtieth of the cost of rare earth magnets that would be used in stators 32 and 33. This difference, in practice, dwarfs the cost of the increased copper necessary for the armature windings. In the case of the linear generator of FIG. 4a, it also obviates the need for an expensive and additional ballast weight, (as shown in FIG. 4b at 37).

An example of this saving is as follows:
Mass of copper windings used in the generator of FIG. 4a: 100 kgs
Cost: 500 units
Mass of low grade magnets: 500 kgs
Cost: 500 units
Total cost: 1000 units
Mass of copper windings used in the generator of FIG. 4b: 33 kgs
Cost: 165 units
Mass of high grade magnets: 56 kgs
Cost: 1680 units
Cost of weight (estimated): 100 units
Total cost: 1945 units

An additional advantage arises, as will be hereinafter explained more fully with reference to FIG. 6, inasmuch that in the case of the low grade magnet generators, and their larger armatures, on account of the fact that the electricity generated occurs over a much longer conductor length, the concentration of I²R resistive losses heat build up within their coils is less per unit volume. This is important because rare earth magnets have a low Curie point, (eg 80-120 degrees Celsius), and can be easily demagnetised were this to be exceeded as a consequence of heat build up. In the case of low grade magnets, such as those known as ferrite, the Curie point is high, eg >200 degrees Celsius, and therefore there is a little risk in this respect.

Thus the arrangement of FIG. 4a provides, in accordance with the invention, substantially the least expensive linear generator in terms of capital cost, while also achieving optimal generation both upon the downstroke and upstroke and avoids the need for ballast weights.

Having established the advantage of using low-grade magnets, a further aspect of the invention is now described relating to the precise choice of the diameters and lengths of the linear generators, specifically the aspect ratio of the diameter of the stator to the length of the armature. This is now illustrated with reference to FIGS. 5a and 5b.

For the type of coaxial linear generator shown in the various figures, namely one in which the armature travels coaxially along its stator, within sensible boundaries, the magnetic field strength emanating from the periphery of the stator remains reasonably constant irrespective of its diameter. Thus, were a particularly thick stator to be employed, the armature would only need to comprise a relatively smaller number of coils inasmuch that the overall conductor length of each coil is longer, given its larger diameter. Such an arrangement is shown at 38 in FIG. 5a. By contrast, were a thinner stator to be employed, more coils would be needed to achieve the same overall conductor length, so resulting in a longer armature, as shown at 39 in FIG. 5b.

In either case it will be appreciated the cost driver for the armature, namely the overall length of conductors embedded therein, is substantially the same. This does not apply however to the cost of the stators 40 and 41. In this case, the respective volumes of magnetic material used are proportional to the square of their respective diameters. For example, the volume of the magnets employed in the thinner stator 41 of FIG. 5b, is one quarter that of 40 in FIG. 5a, being one half of its diameter. (It should be noted that its overall length is however slightly longer to provide the same stroke length L, as shown in both FIGS. 5a and 5b, but this is a lesser consideration given the comparatively great length of 1.)

Thus, clearly, the optimum aspect ratio requires careful selection, to realise the lowest combined costs of armature and stator, while still fulfilling the object of the invention. Using ferrite magnets, this results in a ratio of stroke length to diameter of the stack of permanent magnets in the region of 10:1 to 12:1.

Furthermore, also to be taken into account when designing a wave energy converter at the lowest possible capital cost, is the material used in its construction, for example the cost of the steel used in constructing the cages shown at 42 and 43 in FIGS. 5a and 5b, as well as the length of the linkage means 44.

Thus, in practice, both the aspect ratio governing the diameters of the stators and their armatures, as well as the resulting lengths of the cage and the linkage means, are together optimised in accordance with an aspect of the invention to obtain the lowest combined costs of their respective constituent components.

Concerning the reliable operation of a wave farm, it is of paramount importance that any such installation, located in the inhospitable and difficult environment presented by the seas, will operate as near perfectly for life as possible, and with the minimum number of maintenance visits.

One further advantage of the invention disclosed herein relates to heat dissipation. At normal operating temperatures, as is well known, copper windings suffer from internal heat losses. These can be considerable, for example 25% of the energy generated and fed to the national grid may be lost within their windings. When operating at peak output, they may as a result be required to endure internal temperatures of 100° to 130° Celsius.

In the case of ferrite magnet based stators, on account of the fact that their armatures are physically substantial, this internal heat generation is spread over a larger area, and can be readily dissipated. This is shown schematically at 45 in FIG. 6a. In the case of rare earth based systems however, the same heat must be lost, but self evidently is far more concentrated, as shown schematically at 46 in FIG. 7b. This may result in unfavourable warming of the stator 47, which itself has less thermal capacity due to being smaller.

Under these circumstances, the stator may become dangerously hot. This could be seriously detrimental to the life of a wave farm based upon the use of this type of magnet. For example, in the case of Neodymium Boron Iron rare earth magnets, their Curie point is unfavourably low, being typically 80-120° Celsius, depending on the use of expensive additives. In consequence, it will be appreciated that as a result of the electricity being generated and the consequential heating of the armature coils, an entire wavefarm using such magnets might peradventure demagnetise itself during a storm, were all of its stators to become overheated.

By contrast, with a Curie point of over 200° Celsius, such a catastrophe would be most unlikely to occur to a wavefarm based, in accordance with the invention, upon the use of low grade ferrite magnets.

Numerous variations to the foregoing will be apparent to a person skilled in the art.

1. A wave energy converter comprising:
a linear generator comprising an armature and a stator;
a float connected by a linkage to the armature;
wherein the weight of the armature and the linkage bear downwards upon the float and one of the armature and stator comprises electrical coils and the other of the armature and stator comprises a stack of permanent magnets, the arrangement being such that during the ascending portion of a passing wave, the buoyancy of the float causes the armature to rise, and as the wave falls away, the combined weight of the float, linkage and armature causes the armature to fall, electricity thereby being generated upon the upstroke and the downstroke, the stack of permanent magnets or electrical coils of the armature being sufficiently sized in terms of deadweight to procure that the combined weight of the armature, linkage and float and any other travelling components act sufficiently against the electromotive force being generated by the linear generator upon the downward stroke to ensure that the float descends to the trough of the passing wave.

2. The wave energy converter of claim 1, wherein the electrical coils or stack of permanent magnets of the armature are sufficiently sized in terms of the deadweight to procure that there are sufficient numbers of turns of coils available to be cut by the magnetic fields emanating from the stack of permanent magnets to enable the use of low grade magnetic materials in the stack of permanent magnets while still converting substantially all of the mechanical energy available upon the downstroke or upstroke to electricity.

3. The wave energy converter of claim 1, wherein the electrical coils or stack of permanent magnets of the armature are sufficiently sized in terms of the deadweight to procure that, consequent upon the deadweight of the armature, a reduction is effected in the weight of one or more of the other travelling components needed to cause the required downwards movement.

4. The wave energy converter of claim 1, wherein the stack of permanent magnets is comprised of magnets of a low grade such as having a residual magnetic induction of 2000-5000 Oersteds.

5. The wave energy converter of claim 1, wherein the stack of permanent magnets comprises ferrite permanent magnets.

6. The wave energy converter of claim 1, wherein the permanent magnets of the stack have a Curie point of over 200° C.

7. The wave energy converter of claim 1, wherein the armature comprises the electrical coils and the stator comprises the stack of permanent magnets.

8. The wave energy converter of claim 1, wherein the armature comprises the stack of permanent magnets and the stator comprises the electrical coils.

9. The wave energy converter of claim 1, wherein the size of the float is sufficient such that, during the upstroke, the buoyancy of the float is sufficient to overcome the combined weight of the float, the linkage and the armature, the force needed to overcome the contra electromotive force experienced as electricity is generated in the linear generator and the inertial force necessary to accelerate the respective masses.

10. The wave energy converter of claim 1, wherein the weight of the float, linkage and armature is sufficient such that the need for extra ballast weights connected to the float is avoided.

11. The wave energy converter of claim 1, wherein the energies generated during an upstroke and the downstroke are within 20% of each other, preferably substantially equal.

12. The wave energy converter of claim 1, wherein the size of the float and weight of any moving components including the float, linkage and armature are such that the down thrust due to the weight of the moving components equals substantially the up thrust available as the ascending wave acts upon the buoyancy of the float.

13. The wave energy converter of claim 1, wherein the ratio of the length of the stroke of the armature to the diameter of the stack of permanent magnets lies in the range 10:1 to 12:1.

14. A wave energy converter comprises one or more floats connected by rigid linkage means to the armature(s) of one or more linear generators whereby, in use, the weight of the armature and linkage means bears downwards upon the float(s), the armature(s) of the linear generator housing electrical coils and the stator(s) thereof comprising elongate stacks of alternating permanent magnets and pole pieces, the arrangement being such that during the ascending portion of a passing wave, the buoyancy of the float causes the armature(s) to rise, and as the wave falls away, the combined weight of the float, linkage means and armature(s) causes the armature(s) to fall, electricity thereby being generated both upon the upstroke and the downstroke, the armature being sufficiently sized in terms of the number of coils therein and therefore its deadweight, to procure that
a) the combined weight of the armature and the other travelling components acts sufficiently against the electromotive force being generated upon the downwards stroke to ensure the float descends substantially to its lowest ideal point for the generation of electricity upon the upstroke,
b) there are sufficient numbers of turns within the armature available to be cut by the magnetic fields emanating from the stator to enable the use of low grade magnetic materials therein while still converting substantially all of the mechanical energy available upon the upstroke or downstroke to electricity and
c) consequent upon the said deadweight of the armature, a reduction is effected in the weight(s) of one or more of the other travelling components needed to cause the required said downwards movement.

15. The wave energy converter of claim 2, wherein the electrical coils or stack of permanent magnets of the armature are sufficiently sized in terms of the deadweight to procure that, consequent upon the deadweight of the armature, a reduction is effected in the weight of one or more of the other travelling components needed to cause the required downwards movement.

16. The wave energy converter of claim 2, wherein the size of the float is sufficient such that, during the upstroke, the buoyancy of the float is sufficient to overcome the combined weight of the float, the linkage and the armature, the force needed to overcome the contra electromotive force experienced as electricity is generated in the linear generator and the inertial force necessary to accelerate the respective masses.

17. The wave energy converter of claim 3, wherein the size of the float is sufficient such that, during the upstroke, the buoyancy of the float is sufficient to overcome the combined weight of the float, the linkage and the armature, the force needed to overcome the contra electromotive force experienced as electricity is generated in the linear generator and the inertial force necessary to accelerate the respective masses.

18. The wave energy converter of claim 2, wherein the size of the float and weight of any moving components including the float, linkage and armature are such that the down thrust due to the weight of the moving components equals substantially the up thrust available as the ascending wave acts upon the buoyancy of the float.

19. The wave energy converter of claim 3, wherein the size of the float and weight of any moving components including the float, linkage and armature are such that the down thrust due to the weight of the moving components equals substantially the up thrust available as the ascending wave acts upon the buoyancy of the float.

20. The wave energy converter of claim 16, wherein the size of the float and weight of any moving components including the float, linkage and armature are such that the down thrust due to the weight of the moving components equals substantially the up thrust available as the ascending wave acts upon the buoyancy of the float.
